(19) United States
(12) Patent Application Publication
(10) Pub. No.: US 2014/0099400 A1
(43) Pub. Date: Apr. 10, 2014

(54) PROCESS FOR ENCAPSULATING AN ACTIVE INGREDIENT

(71) Applicant: FIRMENICH SA, Geneva 8 (CH)

(72) Inventors: Jérôme Barra, Geneva 8 (CH); Grégory Dardelle, Geneva 8 (CH); Maurus Marty, Seon (CH); Nathalie Vivien Castoni, Geneva 8 (CH); Marion Wick, Geneva 8 (CH); Dana Zampieri, Plainsboro, NJ (US)

(73) Assignee: FIRMENICH SA, Geneva 8 (CH)

(21) Appl. No.: 13/977,828

(22) PCT Filed: Dec. 5, 2011
(86) PCT No.: PCT/EP2011/071705

§ 371 Date: Dec. 16, 2013

(30) Foreign Application Priority Data
Dec. 20, 2010 (IB) PCT/IB2010/055958

(51) Int. Cl. A23G 4/20; A23L 1/00

(52) U.S. Cl. CPC A23G 4/20; A23L 1/0029
USPC 426/5; 426/61; 426/3

(57) ABSTRACT

The present invention relates to the field of encapsulation. More particularly, it relates to a new process for encapsulating an active ingredient in or on an edible composition.

### TECHNICAL FIELD

The present invention relates to the field of encapsulation. More particularly, it relates to a new process for encapsulating an active ingredient in or on an edible composition.

### PRIOR ART

Processes for preparing encapsulated active ingredients are developed in various industries to protect active ingredients. For instance, in the food industry lots of processes for the encapsulation of flavors are known. Encapsulation mainly has the objective of avoiding losses of volatile components (i) during storage prior to incorporation into the food products, (ii) during mixing of the flavor component with the other food ingredients, (iii) during food processing, such as cooking and baking, (iv) during transportation and storage of the food product and (v) during the preparation of the food product by the end-consumer.

In the flavors industry, a highly desirable benefit of encapsulation is that of having high thermal stability while providing a controlled release of the active upon consumption of the food product. One approach to address this issue is by the encapsulation of flavoring compounds into microorganism walls. This has been described in a number of prior art documents. In the prior art, this type of capsules are always the object of a pre-preparation step in which an active ingredient in liquid form is added to an aqueous dispersion of the microorganism. The so prepared capsules are then dried before being incorporated into food products.

For example, US 2005/0118273 describes a process for the encapsulation of flavors in yeast. A capsules slurry is prepared by adding the flavor to an aqueous dispersion of yeast. Saccharides are adhered to the surface of yeast cell bodies. The obtained capsules are then spray-dried and the spray dried powder is used for the flavoring of food products.

However, the drying step, which is part of the prior art processes is highly time and energy consuming It would thus be advantageous to avoid the pre-preparation and drying steps and to develop a simplified process, thus saving time, costs and energy. Avoiding the drying step would also reduce yield loss during the encapsulation process.

The prior art processes for encapsulating active ingredients in microorganisms also are limited to encapsulation of liquid active ingredient or to active ingredients in solid state, such as crystalline ones, which can be melted before encapsulation. However, active ingredients such as flavors are often provided in powdered form (as solid particles comprising the active ingredient). Advantages of powdered active ingredients over liquid ones are well known to the person skilled in the art. For example the shelf-life of powdered active ingredients such as flavors is much longer than that of liquid ones, in particular due to protection against oxidation. Furthermore, powdered actives have improved handling properties by diminishing their potential irritating properties or reducing their strong smell.

It would therefore be desirable to provide a process for encapsulating an active ingredient such as a flavor directly from its powdered form to an encapsulation system comprising a microorganism. This would have the advantage of enabling the skilled person to handle the active ingredient in powdered form until its encapsulation in a thermally stable encapsulation system capable of releasing the active ingredient in controlled manner.

Such a process is particularly advantageous when the powdered active ingredient is selected from solid particles which require less energy to be produced when compared to dried capsules based on microorganisms.

The copending European patent application EP 09164167.0 describes a method devoid of any pre-preparation step and which avoids spray-drying of the encapsulated system. However, the teaching of this patent application is restricted to an active ingredient in liquid form and is silent with regard to encapsulation of an active directly from solid particles.

It is therefore desirable to address one or more of these problems by providing a process for encapsulating an active ingredient provided in solid particles directly in microorganism cells and by avoiding drying of the encapsulation system before incorporation into a food product.

### SUMMARY OF THE INVENTION

The present invention provides a process for preparing an encapsulated active ingredient in or on an edible composition comprising the steps of
a) adding to water or to an edible composition comprising water
   i) solid particles releasing a liquid active ingredient in the presence of water; and
   ii) an encapsulating material comprising empty microorganism cells; so as to release at least part of the liquid active ingredient in water or in the edible composition comprising water, optionally under heating;
b) mixing and optionally heating the composition obtained in step a) so as to ensure intimate contact of the released liquid active ingredient with the encapsulating material so that at least a portion of the liquid active ingredient is encapsulated within the encapsulating material.
c) if the solid particles and the encapsulating material were added to water alone in step a), mixing the composition as obtained in step a) or in step b) into an edible composition or applying it onto an edible composition.

In another aspect, the invention provides a food product containing an encapsulated active ingredient obtained by the above-described process.

### DETAILED DESCRIPTION

The present inventors have surprisingly found a new process for the preparation of an encapsulated active ingredient in a microorganism in which an active ingredient in the form of solid particles can be used. Such process further has the advantage of not requiring any pre-preparation step. The present process brings a surprising contribution to the encapsulation art because, in view of what is known in this field, namely that the capsule should be pre-loaded with the active ingredient prior to incorporation into a foodstuff, it was not expected that active ingredients would effectively diffuse into the encapsulating material when mixed in or on an edible composition. Indeed, such a composition contains diverse ingredients having properties different from those of water, in which the encapsulation takes place in all prior art documents. In particular the presence of hydrophobic components in the composition would be expected to change the ability of the active ingredients to migrate into the encapsulating material.

Furthermore, it is surprising to be able to encapsulate an active ingredient directly from solid particles to a microorganism encapsulating system. Indeed, the release of the ingredient from the particles would have been expected to be altered by the presence of the microorganism and the presence of the solid particles or remaining parts of it in the medium would have been expected to change the ability of the flavor to diffuse into the microorganism. In particular, the solid particle in which the active ingredient is incorporated would have been expected to constitute an additional barrier between the microorganism and the active ingredient and to restrict the ability of the active ingredient to migrate into the microorganism, so that it could not have been foreseen that encapsulation of the active ingredient in the microorganism would actually occur. Furthermore, the active ingredient being encapsulated in the solid particles is stabilized by the solid carrier and the original solid carrier would be expected to compete with the microorganism in which the active ingredient is intended to be encapsulated, so that encapsulation in the microorganism, could well have been completely or partly prevented by the use of solid particles containing the active ingredient instead of a liquid. The affinity of the active ingredient with the solid particles would indeed have been expected to modify the equilibrium which takes place between the interior and the exterior of the microorganism encapsulation system used in the invention. Surprisingly, it has been found that encapsulation in the microorganism actually takes place.

In the first step of the process, the solid particles and the encapsulating material are added to water or to an edible composition comprising water. Preferably, the solid particle and the encapsulating material are added to an edible composition comprising water. The solid particles and the encapsulating material can be added separately from each other or together in the form of a mixture of powders obtained by dry mixing the solid particles comprising the active ingredient and the encapsulating material in powder form.

During this first step at least part of the active ingredient comprised by the solid particles is released by said particles. Preferably at least 50%, more preferably at least 70%, most preferably all of the active ingredient comprised by the solid particles is released.

Optionally, the solid particles and the encapsulating material can be added to water or to an edible composition comprising water under heating to facilitate the release of the active ingredient. The optimal temperature depends on the type of solid particles used, as explained below.

Any solid particles capable of releasing the active ingredient in water can be used for the purpose of the present invention. However, solid particles comprising an active ingredient already encapsulated in a microorganism are excluded. The particle is intended to be capable of releasing the active ingredient for the purpose of the present invention when release of at least part of the active ingredient is effected directly upon adding the solid particles to water, optionally under heating. The release can further be triggered by heating the mixture in step b) of the process.

In an aspect of the invention, the solid particles include a mineral particles in which or on which a liquid active ingredient has been adsorbed. The mineral particle is preferably porous. For example, such mineral particles can be silica. More preferably, the silica is a synthetic amorphous silica. One specific example of suitable silica in which the active ingredient can be adsorbed is Sipernat® 50, commercially available from Evonik. The use of such particles is particularly advantageous because the preparation of the solid particles used in the invention does not involve any drying step. Taking into account the fact that the process of the present invention does not require any drying step either, it follows that the process of encapsulation and the prior step of forming the solid particle are as a whole energetically very efficient, and are therefore particularly desirable from an environment and sustainability point of view.

Alternatively, the solid particles are solid particles where an active ingredient is encapsulated in a solid matrix of polysaccharide or hydrogel. In the case of hydrogel matrix, it is preferred that such hydrogel matrix is soluble under thermal stress. Examples of such particles comprising a solid matrix comprise are spray-dried and extruded particles. In such case, even if the preparation of the solid particles involves a drying step, such drying step typically requires less energy and is done more rapidly than would be required to dry capsules based on a microorganism such as disclosed in the prior art.

In another alternative, the solid particles are solid core-shell capsules comprising an active ingredient and having a shell which is not chemically cross-linked. The shell is preferably made of a hydrogel that is water soluble under thermal stress. Examples of such capsules are coacervated capsules having a shell that is not cross-linked.

Preferred types of solid particles are selected from
i) mineral particles in which or on which a liquid active ingredient is adsorbed; and
ii) solid particles in which an active ingredient is encapsulated in a matrix of polysaccharides, such as spray dried and extruded particles.

The invention's process provides the advantage of enabling handling of an active ingredient in solid form until its encapsulation in a microorganism directly in or on a food product, thus saving time and energy in the process as a whole.

The active ingredient can be any edible active ingredient provided it is released from the particle in the presence of water. The active ingredient can be selected within a wide range of actives such as pharmaceuticals, vitamins and food additives, such as taste enhancers, aromas or flavors, for example.

In a preferred aspect of the invention, at least part of the active ingredient is characterized by a logP value of at least 1.5 or even preferably of at least 2. More preferably at least 20%, most preferably at least 50% of the active ingredient is characterized by such a logP value. For the purpose of the invention, “logP” is meant as calculated logP as obtained using the EPI suite v3.10; 2000 U.S. Environmental Protection Agency. Ingredients having such a logP value are more easily encapsulated within the microorganism wall.

Preferably, the active ingredient is a flavoring ingredient. For the purpose of the present invention, a “flavoring ingredient” means a compound, which is used in flavoring preparations or compositions to impart a hedonic effect. In other words such an ingredient, to be considered as being a flavoring one, must be recognized by a person skilled in the art as being able to impart or modify in a positive or pleasant way the taste of a composition.

The nature and type of the flavoring ingredients that may be present do not warrant a more detailed description here, which in any case would not be exhaustive, the skilled person being able to select them on the basis of his general knowledge and according to the intended use or application and the desired organoleptic effect. In general terms, these flavoring ingredients belong to chemical classes as varied as alcohols, aldehydes, ketones, esters, ethers, acetates, nitriles, terpenoids, nitrogenous or sulphurous heterocyclic compounds and essential oils, and can be of natural or synthetic origin. Many of these flavoring ingredients are listed in reference texts such as the book by S. Arctander, Perfume and Flavor Chemicals, 1969, Montclair, N.J., USA, or its more recent versions, or in other works of a similar nature, as well as in the abundant patent literature in the field of flavor. It is also understood that the flavoring ingredients may also be compounds known to release in a controlled manner various types of flavoring compounds.

The active ingredient may be a single compound or a mixture of compounds, optionally having different activities. It is particularly advantageous to use a mixture of flavoring compounds optionally together with other actives such as food additives or pharmaceuticals.

The encapsulating material comprises empty microorganism cells. By “empty microorganism cells” we mean that the inner content of the cell has been removed and that no actives have been encapsulated in the microorganism prior to the present process.

The microorganism can be of any type. However preferred types include cells of yeast, unicellular algae such as for example diatoms, and bacteria. The most preferred type of microorganisms is yeast cells.

The encapsulating material can consist of the microorganism cells alone. Alternatively the microorganism cell can be combined with any additional component such as for example a matrix component. The matrix component is preferably suitable to form a polymer matrix. A vast number of structurally different matrix-forming compounds or compositions exist, some of which are mentioned below.

The matrix component may, for example, be formed of or comprise a protein or a carbohydrate. Any matrix component which can be associated with a microorganism cell for the encapsulation of a liquid active ingredient can be used. The nature of suitable matrix component, which would in any case not be exhaustive, is not further detailed here, the skilled person being able to select the suitable matrix component on the basis of his general knowledge or of the teaching of any document relating to the encapsulation of active ingredients in microorganisms.

The microorganism may be pre-treated for increasing its permeability for the active ingredient or for removing the sometimes undesired odour or aroma of the microorganism, for example, using any suitable technique known to the person skilled in the art.

The solid particles and the encapsulating material are added to water or to an edible composition comprising water. In a preferred aspect of the invention, the solid particles and the encapsulating material are added to an edible composition.

The term “edible composition” is defined here as any liquid or solid mixture of ingredients that is intended to be converted into an edible product through normal processing, either alone or in combination with other components. To be considered as an edible composition water must be admixed with further ingredients. Water alone is therefore not considered as an edible composition for the purpose of the present invention. In a preferred aspect of the invention, the active ingredient and the encapsulating material are incorporated into a syrup or a batter. The syrup or batter is preferably used to form the coating part of an edible product, more preferably the coating part of a chewing-gum, of an extruded product or of a product intended to be fried, most preferably the coating part of a chewing-gum, a cereal product or French fries. In another preferred embodiment, the active ingredient and the encapsulating material are incorporated in dough. Dough is preferably intended to be used in baked or fried products, in particular fritters or savoury products. In another aspect of the invention, the edible composition is margarine or the aqueous portion thereof.

In the second step of the process, the composition obtained in step a) is mixed so as to intimately contact the released active ingredient with the encapsulating material. Preferably, the active ingredient in liquid form is intimately contacted with the encapsulating material in the edible composition, in which case the process of the present invention is a process for preparing an encapsulated active ingredient in an edible composition.

Intimate contact is achieved by mixing the composition obtained in step a), using any method known in the art, in particular by low shear mixing, high shear mixing or homogenizing the mixture, preferably by high shear mixing or homogenizing it. Intimate contact between the liquid active ingredient and the encapsulating material and heating enable at least part of the liquid active ingredient to diffuse into the microorganism through the wall, thus effecting encapsulation. Preferably at least 20%, more preferably at least 50% of the active ingredient is encapsulated in the encapsulating material.

Step b) is preferably carried out at a temperature of at least 20° C., more preferably of at least 40° C., most preferably of at least 50° C. When the solid particle comprises a hydrogel which is soluble under thermal stress, the mixture obtained in step a) is heated to a temperature above the melting point of the hydrogel.

The encapsulation speed is very much dependent on the temperature. When the mixture is heated to a temperature of 40° C., the active ingredient is encapsulated in a period of from 1 to 2 hours. When it is carried out at a temperature of about 30° C., the encapsulation takes place in a period of about 4 hours. At 20° C. the encapsulation will take about 16 hours to be completed. A process including heating the mixture to at least 40° C. or even more preferably at least 50° C. is therefore particularly advantageous.

Intimately contacting and/or heating the mixture can be done as a part of the preparation steps of the final product, for example extruding, baking and/or frying. In such case, the obtained encapsulated ingredient is thus incorporated directly in a food product or in a part of a food product. Such food product, which is also an object of the present invention, is then prepared according to any conventional method known to the skilled person. Therefore, the preparation steps of the final food product are not described in further details here. In any case, these steps don't have specific consequences on the encapsulation process, which can take place in any type of flavored product base.

Step c) of the process is specific to the case where the solid particles and the encapsulating material are added to water alone in step a). In such case, the mixture obtained in step a) or in step b) as such is mixed into or applied onto an edible composition. This can be done using any method suitable to prepare an edible composition, such as mixing or coating. This step can also be part of the preparation steps of the final food product, as explained above for step b). In the case where the solid particles and the encapsulating material were already added to an edible composition comprising water in step a), step c) does not apply.

Preferred food products according to the present invention are chewing-gums which are coated with a flavored syrup prepared according to the process of the invention. Other preferred final products include extruded, baked and fried food products containing dough prepared according to the process of the invention, for example fritters, or coated with a syrup or a batter prepared according to the process of the present invention. The present process is particularly appreciated for encapsulation of flavors for use in savoury applications.

The active ingredient encapsulated by the process of the invention is released in a controlled manner from the food product under the effect of predetermined factors such as the presence of a minimum amount of water. These factors are dependent on the exact nature of the encapsulating material and in particular of the type of microorganism and of the optional matrix used. The exact nature of the encapsulating material is determined by the person skilled in the art on the basis of the conditions in which the food product will be consumed. These release conditions are known to the person skilled in the art and are therefore not disclosed in further details here.

### EXAMPLES

The invention will now be described in further detail by way of the following Examples.

### Example 1

Preparation of an Encapsulated Mint Flavor in a Coating Syrup

Solid particles (Solid particles A) of a plated flavoring system were prepared by adding in a blender (SEB Rondo 1000, Selongey, France) over 15 seconds 20 g of a mint Flavor (item number 885106 NT, origin: Firmenich SA) to 10 g of Sipernat® 50 (silicon dioxide, origin: Evonik Degussa GmbH, Hanau-Wolfgang, Germany) and mixing during 30 seconds. A powder with 66.67% flavor load was obtained.

A coating syrup (Coating A) was prepared having the following ingredients.

TABLE 1
Composition of Coating A

| Ingredient | Amount [g] |
|---|---|
| Water | 309.2 |
| Maltisorb P200¹⁾ | 455.8 |
| Arabic gum²⁾ | 15.7 |
| Titanium dioxide³⁾ | 3.9 |
| Solid particles A | 6.6 |
| Encapsulating material⁴⁾ | 8.8 |

¹⁾Origin: Roquette
²⁾Gomme instant IRX 49345, origin: Colloides Naturel International
³⁾Origin: Precolor
⁴⁾S. Cerevisiae, item 954794, origin: Firmenich SA, Geneva, Switzerland

The ingredients listed above were added separately to a beaker and mixed. The slurry was then mixed with a high shear mixer (IKA T18 basic Ultra Turrax®) at 20,000 rpm for 30 seconds at 50° C. and then stirred with a conventional stirrer at 50° C. for 2 hours leading to 800 g of coating syrup.

Preparation of chewing-gums coated with a syrup containing an encapsulated mint flavor (Chewing-gum A)

The freshly prepared Coating A was used to coat classical pellet chewing gums in an industrial coater in 80-100 cycles until the weight of the chewing gum increased by about 30%.

### Example 2

Preparation of an Encapsulated Menthol Flavor in a Coating Syrup

A coating syrup (Coating B) was prepared having the following ingredients.

TABLE 2
Composition of Coating B

| Ingredient | Amount [g] |
|---|---|
| Water | 293.96 |
| Maltisorb P200¹⁾ | 433.32 |
| Arabic gum²⁾ | 14.93 |
| Titanium dioxide³⁾ | 3.71 |
| Solid particles B⁴⁾ | 38.08 |
| Encapsulating material⁵⁾ | 16.00 |

¹⁾Origin: Roquette.
²⁾Gomme instant IRX 49345, origin: Colloides Naturel International.
³⁾Origin: Precolor.
⁴⁾Menthol Spray Dry, item number 550469TP0300, origin: Firmenich SA, Geneva, Switzerland
⁵⁾S. Cerevisiae, item 954794, origin: Firmenich SA, Geneva, Switzerland

The ingredients were added separately to a beaker and mixed. The slurry was then mixed with a high shear mixer (IKA T18 basic Ultra Turrax®) at 20,000 rpm for 30 seconds at 50° C. and then stirred with a conventional stirrer at 50° C. for 2 hours leading to 300.0 g of coating syrup.

Preparation of Chewing-Gum Coated with a Syrup Containing an Encapsulated Menthol Flavor (Chewing-Gum B)

Freshly prepared Coating B was used to coat classical pellet chewing gums in an industrial coater in 80-100 cycles until the weight of the chewing gum increased by about 30%.

1. A process for preparing an encapsulated active ingredient in or on an edible composition comprising the steps of
a) adding to water or to an edible composition comprising water
i) solid particles releasing a liquid active ingredient in the presence of water; and
ii) an encapsulating material comprising empty microorganism cells;
so as to release at least part of the liquid active ingredient, optionally under heating;
b) mixing and optionally heating the composition obtained in step a) so as to ensure intimate contact of the released liquid active ingredient with the encapsulating material so that at least a portion of the liquid active ingredient is encapsulated within the encapsulating material.
c) if the solid particles and the encapsulating material were added to water alone in step a), mixing the composition as obtained in step a) or in step b) into an edible composition or applying it onto an edible composition.

2. The process of claim 1, characterized in that the edible composition is a coating syrup or batter.

3. The process of claim 1, characterized in that the edible composition is a dough.

4. The process of claim 1, characterized in that the edible composition is extrudable.

5. The process as recited in clam 1, characterized in that the encapsulating material comprises empty yeast, algae or bacteria cells.

6. The process as recited in clam 1, characterized in that the empty cells are combined with a matrix component.

7. The process as recited in clam 1, characterized in that the solid particles releasing a liquid active ingredient in water is selected from mineral particles in which a liquid active ingredient is adsorbed, solid particles wherein an active ingredient is encapsulated in a solid matrix of polysaccharide or hydrogel and core-shell capsules comprising an active ingredient and having a shell which is not chemically cross-linked.

8. The process of as recited in clam 1, characterized in that the solid particles releasing a liquid active ingredient in water are selected from mineral particles in which or on which a liquid active ingredient is adsorbed and solid particles in which an active ingredient is encapsulated in a matrix of polysaccharides.

9. The process as recited in clam 7, characterized in that the mineral particles in which a liquid active ingredient is adsorbed are silica particles.

10. The process of as recited in claim 1 any one of claims 1 to 9, characterized in that the active ingredient is a flavor.

11. The process as recited in claim 1, characterized in that at least part of the active ingredient has a logP of at least 1.5.

12. The process as recited claim 1, characterized in that step b) is carried out at a temperature of at least 20° C.

13. A food product containing an encapsulated ingredient obtained by the process as recited in claim 1.

14. The food product of claim 13, characterized in that it is in the form of a chewing-gum or of a fried, baked or extruded product.

15. The food product of claim 13, characterized in that it is in the form of a chewing-gum or of a fried, baked or extruded product coated with a syrup or a batter.
